(19) United States
(12) Patent Application Publication
(10) Pub. No.: US 2025/0297130 A1
(43) Pub. Date: Sep. 25, 2025

(54) POLYAMIDE-IMIDE POLYMER SOLUTION AND METHOD OF PREPARATION THEREOF

(71) Applicant: AXALTA COATING SYSTEMS IP CO., LLC, Wilmington, DE (US)

(72) Inventors: Matthias Franz Gruenberg, Gevelsberg (DE); Stefan Ricken, Bochum (DE)

(73) Assignee: AXALTA COATING SYSTEMS IP CO., LLC, Wilmington, DE (US)

(21) Appl. No.: 19/068,431

(22) Filed: Mar. 3, 2025

Related U.S. Application Data
(60) Provisional application No. 63/569,547, filed on Mar. 25, 2024.

(51) Int. Cl. C09D 179/08; C08G 73/10; C08G 73/14; H01B 3/30; H01B 13/00; H01B 13/06

(52) U.S. Cl. CPC C09D 179/08; C08G 73/1003; C08G 73/14; H01B 3/305; H01B 13/0016; H01B 13/06

(57) ABSTRACT

The present disclosure is directed to a polyamide-imide solution. The solution includes a polyimide-imide polymer; and a solvent comprising, based on the total weight of solvent, from 0.1 to 100 wt. % of i) at least one compound in accordance with Formula (IA) ROOC—A²—COOR, wherein A² is a C₃-C₈ alkylene or a C₆ arylene and each R is independently a C₁-C₂ alkyl group, and from 0 to 99.9 wt. % of ii) at least one aprotic compound which does not meet Formula (IA) and which has a boiling point of at least 150° C. as measured at 1 Bar pressure. Methods for producing the polyamide-imide solution are provided herein. The methods include reacting a diisocyanate component and an anhydride component in the presence of a first solvent and a catalyst to form a first solution, and diluting the first solution with a second solvent to produce a second solution.

### CROSS-REFERENCE TO RELATED APPLICATIONS

This application claims the benefit of U.S. Provisional Application No. 63/569,547, filed Mar. 25, 2024.

### TECHNICAL FIELD

This disclosure relates to a polyamide-imide solution and to a method of preparing such a solution. More particularly, this disclosure is directed to a polyamide-imide solution which comprises a dibasic ester solvent and to the utility of such a solution in the formation of a conductive wire which is provided with an insulating coating comprising the polyamide-imide.

### BACKGROUND

Electrically conductive wires are provided with an insulating coating to inter alia: resist electrical leakage; prevent the wires from coming into contact with other conductors; and, to preserve the material integrity of the wire by protecting it against the effects of abrasion, heat and the ingress of fluids.

Polyamide-imide polymers have been widely accepted in the field of conductive wire insulation on account of their processability, insulating properties and high temperature stability. Such polymers are typically used in a two-coat construction as an overcoating on conductive wires which have been coated with cross-linked polyester materials. The polyamide-imide contributes thermal stability and solvent resistance to the conductive wire that is not provided by the polyester in itself.

Exemplary synthesis methods for polyamide-imide resins include: direct polymerization, under dehydrogenation catalysis, of an aromatic diamine with an aromatic tricarboxylic acid as described in U.S. Pat. No. 3,860,559 and Japanese Patent Laid-Open No. Sho 58-180532; the acid chloride method; and, the isocyanate method.

The acid chloride method comprises the condensation of an aromatic tricarboxylic acid chloride with an aromatic diamine. The condensation reaction may be performed by low temperature homogeneous solution polymerization, typically at room temperature in an non-aqueous polar solvent, or by low temperature precipitation (or interfacial) polymerization in both of an organic solvent which is sparingly soluble in water and an aqueous solvent provided with an acid acceptor. On the basis that these polymerization processes require expensive acid chloride as a raw material and often provide polyamide-imide resins of unfavorable molecular weight distribution, the acid chloride method is no longer considered to be of economic merit.

The isocyanate method, which is the subject of the present disclosure, comprises the decarboxylation reaction of an aromatic diisocyanate with an aromatic tricarboxylic acid anhydride: the reaction is performed in a solvent medium to yield a polyamide-imide polymer solution. On the basis that the diisocyanate is sensitive to water, the decarboxylation reaction must be performed under anhydrous conditions. Moreover, the solvent medium must be carefully selected to obviate gelation during the decarboxylation reaction.

Amide-based solvents have found utility in the isocyanate method as they provide effective polyamide-imide resin solubility in addition to handleability as solvents. Exemplary amide solvents include: N-methylpyrrolidone (NMP), N-ethylpyrrolidone (NEP), N,N-dimethylacetamide and N,N-dimethylformamide. Further DE102014104223A1 discloses the use of 3-methoxy-N,N-dimethylpropanamide as a solvent. However, there are concerns regarding the reprotoxicity of amide-based solvents: this has led to their use being regulated and has prompted a search for alternative solvents to at least partially replace them.

The sole use of γ-butyrolactone (GBL) as solvent was proposed in JP2008-285660A: whilst this solvent is not hygroscopic and was found to dissolve polyamide-imide resins having a narrow molar ratio range of diisocyanate to anhydride, the drying of the obtained solutions was not facile on account of the high boiling point (204° C.) of γ-butyrolactone and poor leveling was observed in certain coating applications. Perhaps consequential to this, JP2012-62355A described the use in polyamide-imide synthesis of γ-butyrolactone in combination with cyclopentanone, US20060240255A1 described the use of butyrolactone in combination with cyclohexanone and methylcyclohexanone and JP2011-210645A proposed the use of γ-butyrolactone in combination with the dipolar aprotic solvent 1,3-dimethylimidazolidinone. However, the cyclohexanone co-solvent is (mal)odorous. Moreover, precipitation of polyamide-imides have been observed where the co-solvent to γ-butyrolactone ratio is not maintained within tightly controlled ranges. Furthermore, the stability of such mixed solutions can be difficult to preserve where adjunct materials, such as nano-particulates are included therein: particle aggregation and inhibitive viscosity increases in the solution have been observed and have necessitated the use of stabilizing diluents such as the aforementioned-and problematic-amide solvents.

There is considered to be a need in art to provide alternative solvents which may at least partially replace the use the γ-butyrolactone and amide solvents either as the solvent phase for the isocyanate process by which the polyamide-imide is synthesized or as the diluents employed to stabilize the polyamide-imide polymer solution obtained in that synthesis.

### BRIEF SUMMARY

In accordance with a first aspect of the present disclosure there is provided a polyamide-imide polymer solution comprising:
a polymer including the structural unit of Formula (II)

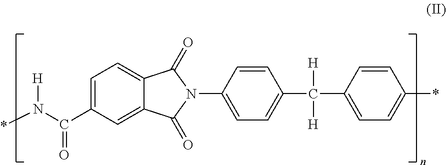

wherein: n is an integer of from 2 to 400; and,
a solvent comprising, based on the total weight of solvent:
   from 0.1 to 100 wt. % of i) at least one compound in accordance with Formula (IA)

ROOC—A²—COOR (IA)
wherein: A² is a C₃-C₈ alkylene or a C₆ arylene; and,
   each R is independently a C₁-C₂ alkyl; and,
from 0 to 99.9 wt. % of ii) at least one aprotic compound which does not meet Formula (IA) and which has a boiling point of at least 150° C. as measured at 1 Bar pressure.

The present disclosure further provides for a method for producing a polyamide-imide solution, said method comprising:
a) reacting, at a temperature of from 60 to 180° C. and in the presence of a first solvent (S¹) and a catalyst:
   a1) a diisocyanate component comprising at least one diisocyanate chosen from: monomeric methylene diphenyl diisocyanate (MDI); polymeric methylene diphenyl diisocyanate (pMDI); hexamethylene diisocyanate (HDI); isophorone diisocyanate (IPDI); dicyclohexylmethane diisocyanate (H-MDI); xylene diisocyanate (XDI); hydrogenated xylene diisocyanate; tolylene diisocyanate (TDI); diphenylsulfone diisocyanate (SDI); m-xylylene diisocyanate; and, mixtures thereof; and
   a2) an anhydride component comprising trimellitic anhydride (TMA)
to produce a first solution of a polyamide-imide polymer, wherein the first solvent (S¹) comprises at least one aprotic compound which has a boiling point of at least 150° C. as measured at 1 Bar pressure; and
b) diluting the first polymer solution with a second solvent (S²) to produce a second solution of the polyamide-imide polymer, wherein the second solvent is distinct from the first solvent;
wherein at least one of the first solvent (S¹) and second solvent (S²) comprises:
   at least one compound in accordance with Formula (I)

ROOC—A¹—COOR (I)
wherein: A is a C₁-C₈ alkylene or a C₆ arylene; and
   each R is independently a C₁-C₂ alkyl group;
   with the proviso that when A is C₂ alkylene, each R is a C₂ alkyl group.

The present disclosure further provides a method for producing a polyamide-imide solution, said method comprising:
a) reacting, at a temperature of from 60 to 180° C. and in the presence of a first solvent (S¹) and a catalyst:
   a1) a diisocyanate component comprising at least one diisocyanate chosen from: monomeric methylene diphenyl diisocyanate (MDI); polymeric methylene diphenyl diisocyanate (pMDI); hexamethylene diisocyanate (HDI); isophorone diisocyanate (IPDI); dicyclohexylmethane diisocyanate (H-MDI); xylene diisocyanate (XDI); hydrogenated xylene diisocyanate; tolylene diisocyanate (TDI); diphenylsulfone diisocyanate (SDI); m-xylylene diisocyanate; and, mixtures thereof; and,
   a2) an anhydride component comprising trimellitic anhydride (TMA) to produce a first solution of a polyamide-imide polymer, wherein the first solvent (S¹) comprises at least one aprotic compound which has a boiling point of at least 150° C. as measured at 1 Bar pressure; and,
b) diluting the first polymer solution with a second solvent (S²) to produce a second solution of the polyamide-imide polymer, wherein the second solvent is distinct from the first solvent; and,
wherein at least one of the first solvent (S¹) and second solvent (S²) comprises:
   at least one compound in accordance with Formula (IA)

ROOC—A²—COOR (IA)
wherein: A² is a C₃-C₈ alkylene or a C₆ arylene; and
   each R is independently a C₁-C₂ alkyl group.

In embodiments of this lattermost method according, the first solvent (S¹) comprises:
i) at least one compound in accordance with Formula (IA)

ROOC—A²—COOR (IA)
wherein: A² is C₃-C₈ alkylene or C₆ arylene; and
   each R is independently a C₁-C₂ alkyl group; and/or,
ii) at least one aprotic compound which does not meet Formula (IA) and which has a boiling point of at least 150° C. as measured at 1 Bar pressure.

For example, the first solvent (S¹) may comprise, based on the total weight of the first solvent (S¹): from 0.1 to 100 wt. % of i) the at least one compound in accordance with Formula (IA); and, from 0 to 99.9 wt. % of ii) at least one aprotic compound which does not meet Formula (IA) and which has a boiling point of at least 150° C. as measured at 1 Bar pressure.

In further exemplary embodiments, the first solvent (S¹) comprises, based on the total weight of the first solvent (S¹):
from 0.5 to 70 wt. % or from 10 to 70 wt. % of i) the at least one compound in accordance with Formula (IA); and,
from 30 to 99.5 wt. % or from 30 to 90 wt. % of ii) at least one aprotic compound which does not meet Formula (IA) and which has a boiling point of at least 150° C. as measured at 1 Bar pressure.

In exemplary compounds in accordance with Formula (IA): A2 is C₃-C₆ alkylene or C₆ arylene; and, each R is independently a C₁-C₂ alkyl group. In other exemplary compounds in accordance with Formula (IA): A2 is —(CH₂) m— or C₆ arylene; m is an integer of from 3 to 6; and, each R is independently a C₁-C₂ alkyl group.

In certain embodiments, each substituent R is the same. In other embodiments, each R is methyl. For instance, the at least one compound in accordance with Formula (IA) may typically be chosen from: dimethyl phthalate; diethyl phthalate; dimethyl glutarate; diethyl glutarate; dimethyl adipate; diethyl adipate; and, mixtures thereof. The use of dimethyl phthalate, dimethyl glutarate, dimethyl adipate or mixtures thereof may be advantageous in certain circumstances. Mention, by way of example, may be made of the use of dimethyl phthalate either alone or in combination with one or more further compounds in accordance with Formula (IA).

In embodiments, part ii) of the first solvent (S¹) comprises at least one nitrogen containing polar aprotic compound which has a boiling point of at least 150° C. as measured at 1 Bar pressure. For example, part ii) of the first solvent may comprise at least one compound chosen from: γ-butyrolactone; cyclohexanone; methylcyclohexanone; N-methyl-2-pyrrolidone (NMP); N-ethyl-2-pyrrolidone (NEP); N-butyl-2-pyrrolidone (NBP); N,N-dimethylacetamide; N-formyl morpholine; N-acetyl morpholine; 3-methoxy N,N′-dimethylpropanamide (MDP); and, mixtures thereof. Mention, by way of example, may be made of the use of γ-butyrolactone in or as part ii) of the first solvent (S¹).

In embodiments of the above methods, the diisocyanate component comprises at least one diisocyanate chosen from: monomeric methylene diphenyl diisocyanate (MDI); polymeric methylene diphenyl diisocyanate (pMDI); hexamethylene diisocyanate (HDI); tolylene diisocyanate (TDI); and, mixtures thereof.

In certain circumstances, monomeric methylene diphenyl diisocyanate (MDI) may be used as either the reactant diisocyanate or one of the reactant diisocyanates in the reacting step a). In a first exemplary embodiment, the diisocyanate component comprises, based on the total number of moles of diisocyanate: from 10 to 90 mol. % of monomeric methylene diphenyl diisocyanate (MDI); and, from 90 to 10 mol. % of at least one diisocyanate chosen from: polymeric methylene diphenyl diisocyanate (pMDI); hexamethylene diisocyanate (HDI); isophorone diisocyanate (IPDI); dicyclohexylmethane diisocyanate (H-MDI); xylene diisocyanate (XDI); hydrogenated xylene diisocyanate; tolylene diisocyanate (TDI); diphenylsulfone diisocyanate (SDI); m-xylylene diisocyanate; and, mixtures thereof.

In a further exemplary embodiment, the diisocyanate component comprises, based on the total number of moles of diisocyanate: from 30 to 70 mol. % of monomeric methylene diphenyl diisocyanate (MDI); and, from 70 to 30 mol. % of at least one diisocyanate chosen from: polymeric methylene diphenyl diisocyanate (pMDI); tolylene diisocyanate (TDI); and, mixtures thereof.

In a still further exemplary embodiment, the diisocyanate component comprises, based on the total number of moles of diisocyanate: from 55 to 65 mol. % of monomeric methylene diphenyl diisocyanate (MDI); and, from 45 to 35 mol. % of tolylene diisocyanate (TDI).

The use of tolylene diisocyanate (TDI) as either the reactant diisocyanate or one of the reactant diisocyanates in the reacting step a) may also be typical. In an exemplary embodiment thereof, the diisocyanate component comprise, based on the total number of moles of diisocyanate: from 10 to 100 mol. % of tolylene diisocyanate (TDI); and, from 0 to 90 mol. % of at least one diisocyanate chosen from: monomeric methylene diphenyl diisocyanate (MDI); polymeric methylene diphenyl diisocyanate (pMDI); hexamethylene diisocyanate (HDI); and, mixtures thereof.

The use of hexamethylene diisocyanate (HDI) as either the reactant diisocyanate or one of the reactant diisocyanates in the reacting step a) may also be typical. In an exemplary embodiment thereof, the diisocyanate component comprise, based on the total number of moles of diisocyanate: from 10 to 100 mol. % of hexamethylene diisocyanate (HDI); and, from 0 to 90 mol. % of at least one diisocyanate chosen from: monomeric methylene diphenyl diisocyanate (MDI); polymeric methylene diphenyl diisocyanate (pMDI); tolylene diisocyanate (TDI); and, mixtures thereof.

In the aforementioned reacting step a), the anhydride component may in certain embodiments comprise, based on the total number of moles of anhydride: from 80 to 100 mol. % of trimellitic anhydride (TMA); and, from 0 to 20 mol. % of least one tetracarboxylic dianhydride.

For example, the anhydride component may comprise, based on the total number of moles of anhydride: from 80 to 100 mol. % of trimellitic anhydride (TMA); and, from 0 to 20 mol. % of least one anhydride chosen from: 3,3′,4,4′-diphenylsulfone tetracarboxylic dianhydride (DSDA); 3,3′,4,4′-benzophenone tetracarboxylic dianhydride (BTDA); 4,4′-oxydiphthalic dianhydride (ODPA); butanetetracarboxylic dianhydride; 5-(2,5-dioxotetrahydro-3-furanyl)-3-methyl-3-cyclohexene-1,2-dicarboxylic anhydride; and, mixtures thereof.

In certain embodiments, the second solvent (S²) comprises at least one compound in accordance with Formula (IA):

ROOC—A²—COOR (IA)
wherein: A2 is a C₃-C₈ alkylene or a C₆ arylene; and,
   each R is independently a C₁-C₂ alkyl group.

In other embodiments, the second solvent (S²) comprises at least one non-polar compound having a boiling point of less than 225° C. Compounds meeting this boiling point condition may typically be chosen from: C1-C8 linear alkanes; cyclic alkanes; C1-C8 branched alkanes; C1-C8 alkyl halides; aromatics; and, mixtures thereof. Further, exemplary compounds meeting this boiling point condition, and which may be used alone or in combination, include: n-pentane; n-hexane; cyclohexane; n-heptane; isooctane; trimethylpentane; toluene; xylene; benzene; and, naphthenics. In an embodiment, the second solvent (S2) comprises xylene.

The present disclosure also provides for a polyamide-imide solution obtained in accordance with the method defined herein above and in the appended claims. In certain embodiments, the polyamide-imide solution may possess a solids content of from 20 to 50 wt. % as determined in accordance with DIN 53216.

A further aspect of the present disclosure provides a process for forming an insulated wire comprising: providing a conductive wire; coating the conductive wire with a polymer solution as defined herein above and in the appended claims; and, subjecting the coated conductive wire to a thermal treatment to remove solvent therefrom.

In accordance with a still further aspect of the present disclosure, there is provided a method for producing a polyamide-imide solution, said method comprising:
a) reacting, at a temperature of from 60 to 180° C. and in the presence of a solvent(S) and a catalyst:
   a1) a diisocyanate component comprising at least one diisocyanate chosen from: monomeric methylene diphenyl diisocyanate (MDI); polymeric methylene diphenyl diisocyanate (pMDI); hexamethylene diisocyanate (HDI); isophorone diisocyanate (IPDI); dicyclohexylmethane diisocyanate (H-MDI); xylene diisocyanate (XDI); hydrogenated xylene diisocyanate; tolylene diisocyanate (TDI); diphenylsulfone diisocyanate (SDI); m-xylylene diisocyanate; and, mixtures thereof; and,
   a2) an anhydride component comprising trimellitic anhydride (TMA) to produce a solution of a polyamide-imide polymer,
      wherein, based on the weight of the solvent (S), the solvent comprises:
from 0.1 to 100 wt. % of i) the at least one compound in accordance with Formula (I)

ROOC—A¹—COOR (I)
wherein: A¹ is a C₁-C₈ alkylene or a C₆ arylene; and,
   each R is independently a C₁-C₂ alkyl group; and,
from 0 to 99.9 wt. % of ii) at least one aprotic compound which does not meet Formula (I) and which has a boiling point of at least 150° C. as measured at 1 Bar pressure.

Where the aspects of the disclosure are described herein as having certain embodiments, any one or more of those embodiments can, unless otherwise stated, be implemented in or combined with any one of the further embodiments, even if that combination is not explicitly described. Expressed differently, the described embodiments are not mutually exclusive unless stated as being such, and permutations thereof remain within the scope of this disclosure.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

As used herein, the singular forms “a”, “an” and “the” include plural referents unless the context clearly dictates otherwise.

The terms “comprising”, “comprises” and “comprised of” as used herein are synonymous with “including”, “includes”, “containing” or “contains”, and are inclusive or open-ended and do not exclude additional, non-recited members, elements or method steps. If used, the phrase “consisting of” is closed and excludes all additional elements. The terminology “consists essentially of” may describe various non-limiting embodiments that are free of one or more optional compounds described herein.

When amounts, concentrations, dimensions and other parameters are expressed in the form of one or more ranges, one or more upper limit values or one or more lower limit values, it should be understood that any ranges obtainable by combining any upper limit with any lower limit are also specifically disclosed, irrespective of whether the obtained ranges are clearly mentioned in the context.

As used herein, the terms “about” or “approximately” apply to all numeric values, whether or not explicitly indicated, save for actual examples. The terminology “about” can describe values ±0.1, 0.5, 1, 2, 3, 4, 5, 6, 7, 8, 9 or 10% in various embodiments.

Further, in accordance with standard understanding, a weight range represented as being “from 0 to x” specifically includes 0 wt. %: the ingredient defined by said range may be absent from the material or may be present in the material in an amount up to x wt. %.

The words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words exemplary and illustrative is intended to present concepts in a concrete fashion.

As used throughout this application, the word “may” is used in a permissive sense-that is meaning to have the potential to-rather than in the mandatory sense.

All percentages, ratios and proportions used herein are given on a weight basis unless otherwise specified.

As used herein, room temperature is 23° C. plus or minus 2° C.

The molecular weights referred to in this specification can be measured with gel permeation chromatography (GPC) using polystyrene calibration standards, such as is done according to ASTM 3536.

As used herein, “drying” of the coating composition refers to the evaporation of any solvent(s) present in the composition (drying); the evaporation of the solvent may be accompanied by the coalescence of the particulate, dispersed or solvated phase of the composition. Such drying may be performed under ambient conditions or by deliberate exposure to heat and/or irradiation. The degree of drying may be partial or complete.

Unless otherwise stated, the term “particle size” refers to the largest axis of the particle. In the case of a generally spherical particle, the largest axis is the diameter.

As used herein, by “D50 particle size” is meant that the particle size distribution is such that at least 50% of the particles by volume have a particle size diameter of less than the specified value. Unless otherwise stated, that particle size is determined by dynamic light scattering (DLS) in combination with a particle size analyser.

As used herein, the term “solids content” refers to the percent by weight of non-volatile components in the composition. The solids content may be determined as the inverse value of the volatile content obtained in accordance with ASTM D2369 Standard Test Method for Volatile Content of Coatings.

As used herein “solvents” are substances capable of dissolving another substance to form a uniform solution; during dissolution neither the solvent nor the dissolved substance undergoes a chemical change.

The term “aprotic solvents” as used herein refers to solvents that do not yield or accept a proton. Conversely “protic solvents” are those solvents capable of yielding or accepting a proton.

Solvents may either be polar or non-polar. The term “polar solvent” as used herein refers to a solvent having a dielectric constant (ε) of more than 5 as measured at 25° C.: the term encompasses both aprotic and protic solvents. The determination of dielectric constant (ε) is well known in the art and is within the knowledge of the skilled person: the use of measured voltages across parallel plate capacitors in such determinations may be mentioned.

The term “Mannich Base” is used herein in accordance with its standard definition in the art as a ketonic amine obtainable from the condensation of a ketone with formaldehyde and ammonia or a primary or secondary amine.

As used herein “diisocyanate” means a compound comprising two −N═C═O functional groups. The term “aromatic diisocyanate” is used herein to describe organic isocyanates in which the isocyanate groups are directly attached to the ring(s) of a mono-or polynuclear aromatic hydrocarbon group.

As used herein “metallic” means any type of metal, metal alloy, or mixture thereof. As used herein, the term “alloy” refers to a substance composed of two or more metals or of a metal and a non-metal which have been intimately united, usually by being fused together and dissolved in each other when molten.

As used herein, “C1-Cn alkyl” group refers to a monovalent group that contains 1 to n carbons atoms, that is a radical of an alkane and includes straight-chain and branched organic groups. As such, a “C1-C4 alkyl” group refers to a monovalent group that contains from 1 to 4 carbons atoms, that is a radical of an alkane and includes straight-chain and branched organic groups. Examples of alkyl groups include, but are not limited to: methyl; ethyl; propyl; isopropyl; n-butyl; isobutyl; sec-butyl; and, tert-butyl. In the present disclosure, such alkyl groups may be unsubstituted or may be substituted with one or more halogen. Where applicable for a given moiety (R), a tolerance for one or more non-halogen substituents within an alkyl group will be noted in the specification.

The term “C1-Cn alkylene” as used herein refers to a divalent radical counterpart of a C1-Cn alkyl group.

As used herein, an “C6-C18 aryl” group used alone or as part of a larger moiety—as in “aralkyl group”—refers to monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. In the present disclosure, such aryl groups may be unsubstituted or may be substituted with one or more halogen. Where applicable for a given moiety (R), a tolerance for one or more non-halogen substituents within an aryl group will be noted in the specification. Exemplary aryl groups include: phenyl; (C1-C4) alkylphenyl, such as tolyl and ethylphenyl; indenyl; naphthalenyl, tetrahydronaphthyl, tetrahydroindenyl; tetrahydroanthracenyl; and, anthracenyl.

As used herein, “alkylaryl” refers to alkyl-substituted aryl groups and “substituted alkylaryl” refers to alkylaryl groups further bearing one or more substituents as set forth above. Further, as used herein “aralkyl” means an alkyl group substituted with an aryl radical as defined above.

The term “Cn arylene” as used herein refers to a divalent radical counterpart of a Cn aryl group.

As used herein a mono-or polynuclear aromatic hydrocarbon group means an essentially planar cyclic hydrocarbon moiety of conjugated double bonds, which may be a single ring or may include multiple condensed (fused) or covalently linked rings. The term aromatic also includes alkylaryl. Typically, the hydrocarbon (main) chain includes 5, 6, 7 or 8 main chain atoms in one cycle. Examples of such planar cyclic hydrocarbon moieties include, but are not limited to, cyclopentadienyl, phenyl, napthalenyl-, [10]annulenyl-(1,3,5,7,9-cyclodecapentaenyl-), [12]annulenyl-, [8]annulenyl-, phenalene (perinaphthene), 1,9-dihydropyrene and chrysene (1,2-benzophenanthrene). Examples of alkylaryl moieties are benzyl, phenethyl, 1-phenylpropyl, 2-phenylpropyl, 3-phenylpropyl, 1-naphthylpropyl, 2-naphthylpropyl, 3-naphthylpropyl and 3-naphthylbutyl.

The term “substituted” refers to substitution with at least one suitable substituent. For completeness: the substituents may connect to the specified group or moiety at one or more positions; and, multiple degrees of substitution are allowed unless otherwise stated. Further, the terms “substitution” or “substituted with” include the implicit proviso that such substitution is in accordance with permitted valence of the substituted atom and the substituent, and that the substitution results in a stable compound that does not spontaneously undergo transformation by, for instance, rearrangement, cyclization or elimination.

The term “substantially free” is intended to mean that the constituent, component, compound, moiety, functional group, element, ion or the like is not deliberately added to the subject material and is present, at most, in only trace amounts which will have no (adverse) effect on the desired properties of the material. As regards compositions, an exemplary trace amount is less than 1000 ppm by weight of the composition. The term “substantially free” encompasses those embodiments where the specified compound, moiety, functional group, element, ion, or other like component is completely absent from the subject material or is not present in any amount measurable by techniques generally used in the art.

The term “anhydrous” as used herein has equivalence to the term “substantially free of water”. Water is not deliberately added to a given composition and is present, at most, in only trace amounts which will have no (adverse) effect on the desired properties of the composition.

The methods of the present disclosure require the reaction, at a temperature of from 60 to 180° C. and in the presence of a solvent and a catalyst, of:
a1) a diisocyanate component; and,
a2) an anhydride component comprising trimellitic anhydride (TMA) to produce a solution of a polyamide-imide polymer, wherein the solvent comprises at least one aprotic compound which has a boiling point of at least 150° C. as measured at 1 Bar pressure.

The reaction may be exemplified by a molar ratio of isocyanate groups to anhydride groups of from 2:3 to 6:1. For example, the molar ratio of isocyanate groups to anhydride groups may be from 2:1 to 4:1 or from 2:1 to 3:1. For completeness, the molar ratio term includes any contribution from monofunctional reactive compounds present such as the mono-isocyanates mentioned herein below.

Depending on the nature of the reactant diisocyanate, the amount of catalyst employed in the reaction is typically in the range from 0.005 to 10 wt. % based on the total weight of the reactants. Exemplary catalysts, which may be used alone or in combination, include: i) tertiary amines and salts of tertiary amines; ii) quaternary ammonium salts, such as benzyltrimethyl ammonium chloride; iii) amidines, such as triazabicyclodecene (TBD), triazabicyclodecene (TBD) diazabicyclononane (DBN) and 1,8-diazabicyclo [5.4.0]undec-7-ene (DBU); iv) guanidines, such as 1,1,3,3-tetramethylguanidine (TMG) and 7-methyl-1,5,7-triazabicyclo[4.4.0]dec-5-ene; and, v) Mannich bases.

In certain embodiments, the catalyst comprises a tertiary amine or salt thereof. And exemplary tertiary amines include but are not limited to: triethylenediamine (TED, 1,4-diazabicyclo [2.2.2]octane); triethylamine; tributylamine; N,N,N′,N′-tetramethyl-1,3-butanediamine; N,N-dimethylcyclohexylamine; N,N-dimethylbenzylamine; α-methylbenzyl dimethylamine; N, N-diethylbenzylamine; triethanolamine, dimethylaminopropylamine; morpholines such as N-methylmorpholine, N-ethyl-morpholine and N-coco-morpholine; imidazolines; and, imidazoles such as N-methylimidazole, N-vinylimidazole and 1,2-dimethylimidazole.

The diisocyanate component of the reactants comprises at least one diisocyanate chosen from: monomeric methylene diphenyl diisocyanate (MDI); polymeric methylene diphenyl diisocyanate (pMDI); hexamethylene diisocyanate (HDI); isophorone diisocyanate (IPDI); dicyclohexylmethane diisocyanate (H-MDI); xylene diisocyanate (XDI); hydrogenated xylene diisocyanate; tolylene diisocyanate (TDI); diphenylsulfone diisocyanate (SDI); m-xylylene diisocyanate; and, mixtures thereof. In certain embodiments, the diisocyanate component comprises at least one diisocyanate chosen from: monomeric methylene diphenyl diisocyanate (MDI); polymeric methylene diphenyl diisocyanate (pMDI); hexamethylene diisocyanate (HDI); tolylenc diisocyanate (TDI); and, mixtures thereof.

The reaction may, in certain circumstances, be exemplified by the presence of monomeric methylene diphenyl diisocyanate (MDI) as the or one reactant diisocyanate. For example, the diisocyanate component may comprise, based on the total number of moles of diisocyanate: from 10 to 90 mol. % of monomeric methylene diphenyl diisocyanate (MDI); and, from 90 to 10 mol. % of at least one diisocyanate chosen from: polymeric methylene diphenyl diisocyanate (pMDI); hexamethylene diisocyanate (HDI); isophorone diisocyanate (IPDI); dicyclohexylmethane diisocyanate (H-MDI); xylene diisocyanate (XDI); hydrogenated xylene diisocyanate; tolylene diisocyanate (TDI); diphenylsulfone diisocyanate (SDI); m-xylylene diisocyanate; and, mixtures thereof. In an further example, the diisocyanate component may comprise, based on the total number of moles of diisocyanate: from 30 to 70 mol. % of monomeric methylene diphenyl diisocyanate (MDI); and, from 70 to 30 mol. % of at least one diisocyanate chosen from: polymeric methylene diphenyl diisocyanate (pMDI) and tolylene diisocyanate (TDI). In a still further example, the diisocyanate component may comprise, based on the total number of moles of diisocyanate: from 35 to 65 mol. % of monomeric methylene diphenyl diisocyanate (MDI); and, from 65 to 35 mol. % of tolylene diisocyanate (TDI).

The reaction may, in other circumstances, be exemplified by the presence of tolylene diisocyanate (TDI) as the or one diisocyanate reactant. For example, the diisocyanate component may comprise, based on the total number of moles of diisocyanate: from 10 to 100 mol. % of tolylene diisocyanate (TDI); and, from 0 to 90 mol. % of at least one diisocyanate chosen from: monomeric methylene diphenyl diisocyanate (MDI); polymeric methylene diphenyl diisocyanate (pMDI); hexamethylene diisocyanate (HDI); and, mixtures thereof.

The reaction may, in still further circumstances, be exemplified by the presence of hexamethylene diisocyanate (HDI) as the or one diisocyanate reactant. For example, the diisocyanate component may comprise, based on the total number of moles of diisocyanate: from 10 to 100 mol. % of hexamethylene diisocyanate (HDI); and, from 0 to 90 mol. % of at least one diisocyanate chosen from: monomeric methylene diphenyl diisocyanate (MDI); polymeric methylene diphenyl diisocyanate (pMDI); tolylene diisocyanate (TDI); and, mixtures thereof.

It is not strictly precluded for the diisocyanate component to comprise further diisocyanates in addition to those recited, which supplementary diisocyanates may be aliphatic, cycloaliphatic or aromatic. Such further diisocyanate may typically constitute from 0 to 20 mol. %, such as from 0 to 10 mol. % of the total number of moles of diisocyanate. Exemplary aliphatic isocyanates include but are not limited: ethylene diisocyanate; trimethylene diisocyanate; tetramethylene diisocyanate; octamethylene diisocyanate; nonamethylene diisocyanate; decamethylene diisocyanate; 1,6,11-undecanetriisocyanate; bis(isocyanatocthyl)-carbonate; and, bis(isocyanatocthyl)ether. Exemplary cycloaliphatic polyisocyanates include, but are not limited to, dicyclohexylmethane 4,4′-diisocyanate (H12MDI); 1-isocyanatomethyl-3-isocyanato-1,5,5-trimethyl-cyclohexane (isophorone diisocyanate, IPDI); cyclohexane 1,4-diisocyanate; hydrogenated xylylene diisocyanate (H6XDI); 1-methyl-2,4-diisocyanato-cyclohexane; m- or p-tetramethylxylene diisocyanate (m-TMXDI, p-TMXDI); and, dimer fatty acid diisocyanate. Exemplary aromatic diisocyanates include, but are not limited to: naphthalene 1,5-diisocyanate; xylylene diisocyanate (XDI); diphenyl-dimethylmethane 4,4′-diisocyanate; di- and tetraalkyl-diphenylmethane diisocyanates; dibenzyl 4,4′-diisocyanate; phenylene 1,3-diisocyanate; and, phenylene 1,4-diisocyanate.

The anhydride reactive component comprises trimellitic anhydride (TMA). The presence of further anhydride functional compounds is not precluded however. Thus, in certain embodiments, the anhydride component comprises, based on the total number of moles of anhydride: from 80 to 100 mol. % of trimellitic anhydride (TMA); and, from 0 to 20 mol. % of least one tetracarboxylic dianhydride. For example. the anhydride component may comprise, based on the total number of moles of anhydride: from 80 to 100 mol. % of trimellitic anhydride (TMA); and, from 0 to 20 mol. % of least one anhydride chosen from: 3,3′,4,4′-diphenylsulfone tetracarboxylic dianhydride (DSDA); 3,3′,4,4′-benzophenone tetracarboxylic dianhydride (BTDA); 4,4′-oxydiphthalic dianhydride (ODPA); butanetetracarboxylic dianhydride; 5-(2,5-dioxotetrahydro-3-furanyl)-3-methyl-3-cyclohexene-1,2-dicarboxylic anhydride; and, mixtures thereof.

The reacting components may in certain embodiments further comprise a3) at least one polycarboxylic acid. The reaction mixture may, for instance, comprise from 0 to 10 mol. % or alternatively from 0 to 5 mol. % of a3) said at least one polycarboxylic acid, based on the total number of moles of anhydride.

The polycarboxylic acid may be aliphatic, cycloaliphatic or aromatic and will conventionally comprise from 2 to 4 carboxyl groups. Examples of suitable dicarboxylic acids include but are not limited to: adipic acid; glutaric acid; pimelic acid; suberic acid; nonanedicarboxylic acid; decanedicarboxylic acid; succinic acid; maleic acid; sebacic acid; azelaic acid; terephthalic acid; isophthalic acid; o-phthalic acid; tetrahydrophthalic acid; hexahydrophthalic acid; trimellitic acid; and, 1,4-cyclohexanedicarboxylic acid. Exemplary higher carboxylic acids include: 3,3′,4,4′-benzophenonetetracarboxylic acid; 2,3,3′,4′-benzophenonetetracarboxylic acid; pyromellitic acid; 3,3′,4,4′-biphenyltetracarboxylic acid; 2,3,3′,4′-biphenyltetracarboxylic acid.

The reaction step can be run at sub-atmospheric, atmospheric, or super-atmospheric pressures but pressures at or slightly above atmospheric pressure are typical. Mention in this regard may be made of pressures of from 50 to 150 kPa, for example from 75 to 125 kPa.

Typically, the aforementioned reaction will be conducted over a duration of from 2 to 10 hours in toto. The reaction temperature, which is maintained for this duration, is typically from 80 to 180° C., such as from 80 to 160° C.

It is noted that the reaction may be conducted at more than one temperature within the provided ranges. For instance, the reaction may be performed in sub-stages comprising a first timespan wherein the reaction mixture is held at a first temperature and a second timespan wherein the reaction mixture is held at a second temperature. Conventionally, the second temperature will be higher than the first temperature and will serve to drive the reaction to completion.

The timespan of any such sub-stages may each be of fixed length. Alternatively, a given timespan may be determined by monitorable points in the reaction. For instance, a first timespan may be determined by the cessation of carbon dioxide evolution, after which cessation the temperature of the reaction mixture is elevated for either a fixed time or to second monitored point, such as the attainment of a particular dynamic viscosity of the polymer solution. Aside from viscosity measurement and flow measurement of gaseous CO2 evolution, the progress of the reaction may be monitored by known techniques of which mention may be made of 1H NMR, Fourier Transform Infrared Spectroscopy, Ultra Performance Liquid Chromatography (UPLC) or thin layer chromatography (TLC).

Independently of the temperature regime of the reaction, it is considered that the reaction in total or a first sub-stage of the reaction step may be performed in either batch or semi-batch mode. The batch reaction mode assumes that all reactants are added to the reaction vessel at the beginning of the reaction. The semi-batch reaction mode assumes that a fraction of the reactants are added to the reaction vessel at the beginning of the reaction and the remaining fraction is fed to the vessel either periodically or continuously either during the entire reaction duration or a first sub-stage thereof.

The reaction may be deliberately terminated by cooling the reaction mixture, by adding the diluent solvent to be discussed below and/or by adding a mono-ol—such as a C1-C6 alkanol—to capture any residual isocyanate functionalities. It is also envisaged that the reaction might be terminated by the addition of a mono-isocyanate, such as a mono-isocyanate of the formula Rx-NCO wherein: Rx is C1-C18 alkyl or C6-C18 aryl. Exemplary mono-isocyanates in accordance with this formula include: methyl isocyanate; isopropyl isocyanate; n-butyl isocyanate; tert-butyl isocyanate; n-hexyl isocyanate; cyclohexyl isocyanate; stearyl isocyanate; phenyl isocyanate; m-, p- or -tolyl isocyanate; p-isopropylphenyl isocyanate; 2,6-diisopropylphenyl isocyanate; and, 1-naphthyl isocyanate.

The above described reaction is performed in the presence of a solvent. That solvent may provide a reaction medium and the amount of solvent present during the reaction may be at least that which is sufficient for the reaction to proceed and for the polymer products thereof to be dissolved at the reaction temperature.

The present disclosure provides, in an exemplary embodiment, a method for producing a polyamide-imide solution, said method comprising:
a) reacting, at a temperature of from 60 to 180° C. and in the presence of a first solvent (S¹) and a catalyst:
   a1) the diisocyanate component as described above; and,
   a2) the anhydride component comprising trimellitic anhydride (TMA) as described herein above,
      to produce a first solution of a polyamide-imide polymer, wherein the first solvent (S¹) comprises at least one aprotic compound which has a boiling point of at least 150° C. as measured at 1 Bar pressure; and,
b) diluting the first polymer solution with a second solvent (S²) to produce a second solution of the polyamide-imide polymer, wherein the second solvent (S²) is distinct from the first solvent (S¹); and,
wherein at least one of the first solvent (S¹) and second solvent (S²) comprises:
   at least one compound in accordance with Formula (I)

ROOC—A—COOR (I)
wherein: A is a C₁-C₈ alkylene or a C₆ arylene; and,
   each R is independently a C₁-C₂ alkyl group
   with the proviso that when A is C₂ alkylene, each R is a C₂ alkyl group.

In embodiments, the second solvent is substantially free of dimethyl succinate. In other embodiments, both the first and second solvent are substantially free of dimethyl succinate.

In accordance with a second exemplary embodiment of this method, at least one compound in accordance with Formula (I) is present in the reaction step a). For surety, the present disclosure is intended to encompass the performance of step a) only in this circumstance and thereby the polymer solution which is the product of that reaction step.

There is provided a method of preparing a producing a polyamide-imide solution, said method comprising:
a) reacting, at a temperature of from 60 to 180° C. and in the presence of a first solvent (S¹) and a catalyst:
   a1) a diisocyanate component comprising at least one diisocyanate chosen from: monomeric methylene diphenyl diisocyanate (MDI); polymeric methylene diphenyl diisocyanate (pMDI); hexamethylene diisocyanate (HDI); isophorone diisocyanate (IPDI); dicyclohexylmethane diisocyanate (H-MDI); xylene diisocyanate (XDI); hydrogenated xylene diisocyanate; tolylene diisocyanate (TDI); diphenylsulfone diisocyanate (SDI); m-xylylene diisocyanate; and, mixtures thereof; and,
   a2) an anhydride component comprising trimellitic anhydride (TMA) to produce a first solution of a polyamide-imide polymer,
b) diluting the first polymer solution with a second solvent (S²) to produce a second solution of the polyamide-imide polymer, wherein the second solvent (S²) is distinct from the first solvent (S¹); and,
wherein, based on the total weight of the first solvent (S¹), the first solvent (S¹) comprises:
   from 0.1 to 100 wt. % of i) the at least one compound in accordance with Formula

(I)

ROOC—A¹—COOR (I)
wherein: A¹ is a C₁-C₈ alkylene or a C₆ arylene; and,
   each R is independently a C₁-C₂ alkyl group; and,
from 0 to 99.9 wt. % of ii) at least one aprotic compound which does not meet Formula (I) and which has a boiling point of at least 150° C. as measured at 1 Bar pressure.

In an embodiment, the first solvent (S¹) may comprise, based on the total weight of first solvent (S¹): from 0.5 to 70 wt. % of i) the at least one compound in accordance with Formula (I); and, from 30 to 99.5 wt. % of ii) at least one aprotic compound which does not meet Formula (I) and which has a boiling point of at least 150° C. as measured at 1 Bar pressure. In an alternative embodiment, the first solvent (S¹) may comprise, based on the total weight of solvent first (S¹): from 10 to 70 wt. % of i) the at least one compound in accordance with Formula (I); and, from 30 to 90 wt. % of ii) at least one aprotic compound which does not meet Formula (I) and which has a boiling point of at least 150° C. as measured at 1 Bar pressure.

In exemplary compound(s) in accordance with Formula (I) of the first solvent (S¹): A1 is C1-C6 alkylene or C6 arylene; and, each R is independently a C1-C2 alkyl group. In other exemplary compounds: A1 is —(CH2)m— or C6 arylene, wherein m is an integer of from 1 to 6; and, each R is independently a C1-C2 alkyl group.

In certain embodiments of Formula (I), each substituent R is the same. In other embodiments of Formula (I), each R is methyl. Illustrative compounds in accordance with Formula (I) which may be used in the first solvent (S¹) either individually or in combination include: dimethyl phthalate; diethyl phthalate; dimethyl malonate; diethyl malonate; dimethyl succinate; diethyl succinate; dimethyl glutarate; diethyl glutarate; dimethyl adipate; and, diethyl adipate. For example, the at least one compound in accordance with Formula (I) may be chosen from: dimethyl phthalate; dimethyl malonate; dimethyl succinate; dimethyl glutarate; dimethyl adipate; and, mixtures thereof. In an exemplary embodiment, the at least one compound in accordance with Formula (I) present in the first solvent (S¹) comprises dimethyl phthalate.

The first solvent (S¹) may comprise ii) at least one aprotic compound which does not meet Formula (I) and which has a boiling point of at least 150° C. as measured at 1 Bar pressure. Exemplary compounds which may be present within part ii) of the solvent (S¹) and which may be used alone or in combination include: γ-butyrolactone (GBL); cyclohexanone; methylcyclohexanone; 1,3-dimethyl-2-imidazolidinone; N-methyl-2-pyrrolidone (NMP); N-ethyl-2-pyrrolidone (NMP); N-butyl-2-pyrrolidone (NBP); N,N-dimethyl formamide (DMF); N,N-diethyl formamide (DEF); N,N-dimethylacetamide (DMAc); N,N-diethyl acetamide; 3-methoxy N,N′-dimethylpropanamide (MDP); N-formyl morpholine; N-acetyl morpholine; phenyl methanol; 2,6-xylenol; 4-methylphenol; hexamethyl phosphoramide; and, dimethyl sulfoxide (DMSO).

Exemplary compounds which may be present in part ii) and which may be used alone or in combination include: γ-butyrolactone (GBL); cyclohexanone; methylcyclohexanone; N-methyl-2-pyrrolidone (NMP); N-ethyl-2-pyrrolidone (NMP); N-butyl-2-pyrrolidone (NBP); N,N-dimethylacetamide (DMAc); N-formyl morpholine; N-acetyl morpholine; and, 3-methoxy N,N′-dimethylpropanamide (MDP). In certain embodiments, part ii) of the solvent (S¹) comprises γ-butyrolactone (GBL).

The method of this embodiment can include the step (b)) of diluting the first polymer solution with a second solvent (S²) to produce a second solution of the polyamide-imide polymer. The second solvent (S²) is distinct from the first solvent (S¹) by which is meant that the compositions of the first and second solvent are not identical. The first (S¹) and second (S²) solvents may, as such, comprise different compounds. It is also considered that the second solvent (S²) may comprise the same constituent compounds as the first solvent (S¹) but be distinguished therefrom by the ratio by weight of those constituent compounds.

The second solvent (S²) may comprise at least one compound in accordance with Formula (I):

ROOC—A¹—COOR (I)
wherein: A¹ is a C₁-C₈ alkylene or a C₆ arylene; and,
   each R is independently a C₁-C₂ alkyl group.

The aforementioned recitals for substituents A and R of Formula (I) are applicable when a compound in accordance with this Formula is present in the second solvent (S²). Moreover, illustrative compounds which may be used as diluents, individually or in combination include: dimethyl phthalate; diethyl phthalate; dimethyl malonate; diethyl malonate; dimethyl succinate; diethyl succinate; dimethyl glutarate; diethyl glutarate; dimethyl adipate; and, diethyl adipate. For example, the at least one diluent compound in accordance with Formula (I) in the second solvent (S²) may be chosen from: dimethyl phthalate; dimethyl glutarate; dimethyl adipate; and, mixtures thereof. In another exemplary embodiment, the second solvent (S²) comprises dimethyl phthalate.

Independently of the presence a compound of Formula (I) in the second solvent (S²), the second solvent (S²) may comprise at least one non-polar compound having a boiling point of less than 225° C. Compounds meeting this boiling point condition may typically be chosen from: C1-C8 linear alkanes; cyclic alkanes; C1-C8 branched alkanes; C1-C8 alkyl halides; aromatics; and, mixtures thereof. Further, exemplary compounds meeting this boiling point condition, and which may be used alone or in combination, include: n-pentane; n-hexane; cyclohexane; n-heptane; isooctane; trimethylpentane; toluene; xylene; benzene; and, naphthenics. In an embodiment, the second solvent (S²) comprises xylene.

The present disclosure provides a method for producing a polyamide-imide solution, said method comprising:
a) reacting, at a temperature of from 60 to 180° C. and in the presence of a first solvent (S¹) and a catalyst:
   a1) a diisocyanate component comprising at least one diisocyanate chosen from: monomeric methylene diphenyl diisocyanate (MDI); polymeric methylene diphenyl diisocyanate (pMDI); hexamethylene diisocyanate (HDI); isophorone diisocyanate (IPDI); dicyclohexylmethane diisocyanate (H-MDI); xylene diisocyanate (XDI); hydrogenated xylene diisocyanate; tolylene diisocyanate (TDI); diphenylsulfone diisocyanate (SDI); m-xylylene diisocyanate; and, mixtures thereof; and,
   a2) an anhydride component comprising trimellitic anhydride (TMA) to produce a first solution of a polyamide-imide polymer, wherein the first solvent (S¹) comprises at least one aprotic compound which has a boiling point of at least 150° C. as measured at 1 Bar pressure; and,
b) diluting the first polymer solution with a second solvent (S²) to produce a second solution of the polyamide-imide polymer, wherein the second solvent (S²) is distinct from the first solvent (S¹); and,
wherein at least one of the first solvent (S¹) and second solvent comprises: at least one compound in accordance with Formula (IA)

ROOC—A²—COOR (IA)
wherein: A² is a C₃-C₈ alkylene or a C₆ arylene; and,
   each R is independently a C₁-C₂ alkyl group.

In embodiments of this method according, the first solvent (S¹) comprises:
i) at least one compound in accordance with Formula (IA)

ROOC—A²—COOR (IA)
A² is a C₃-C₈ alkylene or a C₆ arylene; and,
   each R is independently a C₁-C₂ alkyl group; and/or, wherein:
ii) at least one aprotic compound which does not meet Formula (IA) and which has a boiling point of at least 150° C. as measured at 1 Bar pressure.

For surety, it is noted that at least one compound in accordance with Formula (I) may be present in: the reaction step (a)) yielding a first polyamide-imide polymer solution; the step in which that first polymer solution is stabilized by dilution (b)); or, both of these steps.

In certain embodiments, the artisan may elect to include the compound(s) in accordance with Formula (I) in or as the first solvent (S¹). The compound(s) of Formula (I) may therefore constitute all of the first solvent or may be included therein as a trace additive. For example, the first solvent (S¹) may comprise, based on the total weight of first solvent (S¹): from 0.1 to 100 wt. % of i) the at least one compound in accordance with Formula (I); and, from 0 to 99.9 wt. % of ii) at least one aprotic compound which does not meet Formula (I) and which has a boiling point of at least 150° C. as measured at 1 Bar pressure.

In an embodiment, the first solvent (S¹) comprises, based on the total weight of first solvent (S¹): from 0.5 to 70 wt. % of i) the at least one compound in accordance with Formula (I); and, from 30 to 99.5 wt. % of ii) at least one aprotic compound which does not meet Formula (I) and which has a boiling point of at least 150° C. as measured at 1 Bar pressure. In another embodiment, the first solvent (S¹) comprises, based on the total weight of first solvent (S¹): from 10 to 70 wt. % of i) the at least one compound in accordance with Formula (I); and, from 30 to 90 wt. % of ii) at least one aprotic compound which does not meet Formula (I) and which has a boiling point of at least 150° C. as measured at 1 Bar pressure.

In exemplary compounds in accordance with Formula (IA): A2 is C3-C6 alkylene or C6 arylene; and, each R is independently a C1-C2 alkyl group. In other exemplary compounds in accordance with Formula (IA): A2 is —(CH2)m— or C₆ arylene, wherein m is an integer of from 3 to 6; and, each R is independently a C₁-C₂ alkyl group.

In certain embodiments of Formula (IA), each substituent R is the same. In other embodiments of Formula (IA) each R is methyl. Illustrative compounds in accordance with Formula (IA), which may be used individually or in combination include: dimethyl phthalate; diethyl phthalate; dimethyl glutarate; diethyl glutarate; dimethyl adipate; and, diethyl adipate. For instance, the at least one compound in accordance with Formula (IA) may be chosen from: dimethyl phthalate; dimethyl glutarate; and, dimethyl adipate. In an further illustrative embodiment, the at least one compound in accordance with Formula (IA) comprises dimethyl phthalate.

The first solvent (S¹) may comprise ii) at least one aprotic compound which does not meet Formula (IA) and which has a boiling point of at least 150° C. as measured at 1 Bar pressure. In an embodiment, compounds which may constitute part ii) of the first solvent (S¹) and which may be used alone or in combination include: γ-butyrolactone (GBL); cyclohexanone; methylcyclohexanone; 1,3-dimethyl-2-imidazolidinone; N-methyl-2-pyrrolidone (NMP); N-ethyl-2-pyrrolidone (NMP); N-butyl-2-pyrrolidone (NBP); N,N-dimethyl formamide (DMF); N,N-diethyl formamide (DEF); N,N-dimethylacetamide (DMAc); N,N-diethyl acetamide; 3-methoxy N,N′-dimethylpropanamide (MDP); N-formyl morpholine; N-acetyl morpholine; phenyl methanol; 2,6-xylenol; 4-methylphenol; hexamethyl phosphoramide; and, dimethyl sulfoxide (DMSO).

In another embodiment, compounds which may constitute part ii) of the first solvent (S¹) and which may be used alone or in combination include: γ-butyrolactone (GBL); cyclohexanone; methylcyclohexanone; N-methyl-2-pyrrolidone (NMP); N-ethyl-2-pyrrolidone (NMP); N-butyl-2-pyrrolidone (NBP); N,N-dimethylacetamide (DMAc); N-formyl morpholine; N-acetyl morpholine; and, 3-methoxy N,N′-dimethylpropanamide (MDP). In a still further embodiment, part ii) of the first solvent (S¹) comprises γ-butyrolactone (GBL).

The method of this embodiment includes the step (b)) of diluting the first polymer solution with a second solvent (S²) to produce a second solution of the polyamide-imide polymer. The second solvent (S²) is distinct from the first solvent (S¹) by which is meant that the compositions of the first and second solvent are not identical. The first (S¹) and second (S²) solvents may, as such, comprise different compounds. It is also considered that the second solvent (S²) may comprise the same constituent compounds as the first solvent (S¹) but be distinguished therefrom by the ratio by weight of those constituent compounds.

The second solvent (S²) comprises at least one compound in accordance with Formula (IA):

ROOC—A²—COOR (IA)
wherein: A² is a C₃-C₈ alkylene or a C₆ arylene; and,
   each R is independently a C₁-C₂ alkyl group.

Where no compound in accordance with Formula (IA) is present in the first solvent (S¹), the second solvent (S²) must comprise such a compound. Where a compound in accordance with Formula (IA) is present in that first solvent (S¹), this does not preclude such a compound being present in the diluting second solvent (S²).

The aforementioned recitals for substituents A2 and R of Formula (IA) are applicable when a compound in accordance with this Formula is present in the second solvent (S2). Thereby illustrative compounds which may be used in the second solvent (S2), individually or in combination include: dimethyl phthalate; diethyl phthalate; dimethyl glutarate; diethyl glutarate; dimethyl adipate; and, diethyl adipate. For example, the at least one compound in accordance with Formula (IA) used in the second solvent (S2) may be chosen from: dimethyl phthalate; dimethyl glutarate; dimethyl adipate; and, mixtures thereof. In an embodiment, the second solvent (S2) comprises dimethyl phthalate.

Independently of the presence a compound of Formula (IA) in the second solvent (S2), the second solvent (S2) may comprise at least one non-polar compound having a boiling point of less than 225° C. Compounds meeting this boiling point condition may typically be chosen from: C1-C8 linear alkanes; cyclic alkanes; C1-C8 branched alkanes; C1-C8 alkyl halides; aromatics; and, mixtures thereof. Further, exemplary compounds meeting this boiling point condition, and which may be used alone or in combination, include: n-pentane; n-hexane; cyclohexane; n-heptane; isooctane; trimethylpentane; toluene; xylene; benzene; and, naphthenics. In an embodiment, the second solvent (S2) comprises xylene.

In the afore-described methods, there is no particular intention to limit the amount of the second solvent (S2) which is added in the dilution step but that dilution may typically achieve a stable solution of workable viscosity. However, it may be disadvantageous to dilute the first polymer solution to such an extent that subsequent obtention of the solid polyamide-imide from the polymer solution requires a significant energetic cost in evaporative removal of the solvents. As such, it is typical for the dilution step b) to yield a polyamide-imide solution which possess a solids content of from 20 to 50 wt. %, for example from 25 to 45 wt. % or from 25 to 40 wt. % as determined in accordance with DIN 53216.

The polymer solutions as defined herein above have utility in the coating of conductive wires to provide an insulating layer thereon. Whilst the discussion below focuses upon that use of polyamide-imides, this does not preclude the use of the polyamide-imide solution as a varnish for other substrates or the use of the polyamide-imide in the form of a free-standing film having utility, for instance, in phase insulation and coil wrapping.

The obtained polymer solutions may be used as such in the formation of an insulating coating layer or layers on a conductive wire. However, in certain embodiments, a coating composition will be applied to the conductive wire, which composition will comprise the polymer solution together with adjuvants and additives that can impart improved properties to the compositions and the coatings obtained therefrom. For instance, the adjuvants and additives may impart to the insulative coating one or more of: improved tensile strength; improved clastic properties; improved clastic recovery; longer enabled processing time; faster drying time; improved thermal conductivity; and, reduced coefficient of thermal expansion. Included among such adjuvants and additives are: tougheners; plasticizers; stabilizers including UV stabilizers; adhesion promoters; flame retardants; lubricants, including polytetrafluoroethylene (PTFE) and graphite; rheological adjuvants; and, colorants such as pigments or dyes.

A “plasticizer” for the purposes of this disclosure is a substance that decreases the viscosity of the composition and thus facilitates its processability. Herein the plasticizer may constitute up to 10 wt. % or up to 5 wt. %, based on the total weight of the composition, and is typically chosen from: diurethanes; ethers of monofunctional, linear or branched C4-C16 alcohols, such as Cetiol OE (obtainable from BASF); esters of abietic acid, butyric acid, thiobutyric acid, acetic acid, propionic acid esters and citric acid; esters based on nitrocellulose and polyvinyl acetate; fatty acid esters; dicarboxylic acid esters; esters of OH-group-carrying or epoxidized fatty acids; glycolic acid esters; benzoic acid esters; phosphoric acid esters; sulfonic acid esters; trimellitic acid esters; polyether plasticizers, such as end-capped polyethylene or polypropylene glycols; polystyrene; hydrocarbon plasticizers; chlorinated paraffin; and, mixtures thereof.

“Stabilizers” for purposes of this disclosure are to be understood as antioxidants, thermal stabilizers or hydrolysis stabilizers. Herein stabilizers may constitute in toto up to 10 wt. % or up to 5 wt. %, based on the total weight of the composition. Standard commercial examples of stabilizers suitable for use herein include: sterically hindered phenols; thioethers; benzotriazoles; benzophenones; hydroquinones; benzoates; cyanoacrylates; acrylates; amines of the hindered amine light stabilizer (HALS) type; phosphorus; sulfur; and, mixtures thereof.

The coating compositions may comprise a rheology control agent of which electrically non-conductive fillers provide an example. Broadly, there is no particular intention to limit the shape of the particles employed as non-conductive fillers: particles that are acicular, spherical, ellipsoidal, cylindrical, bead-like, cubic or platelet-like may be used alone or in combination. Moreover, it is envisaged that agglomerates of more than one particle type may be used. Equally, there is no particular intention to limit the size of the particles employed as non-conductive fillers. However, such non-conductive fillers will conventionally have an average volume particle size (Dv50), as measured by laser diffraction/scattering methods, of from 0.01 to 1500 μm, for example from 0.01 to 50 μm.

Exemplary non-conductive fillers include but are not limited to calcium carbonate, calcium oxide, calcium hydroxide (lime powder), precipitated and/or pyrogenic silica, zeolites, bentonites, wollastonite, magnesium carbonate, diatomite, barium sulfate, alumina, clay, talc, titanium oxide, iron oxide, zinc oxide, sand, quartz, flint, mica, glass beads, glass powder, boron nitride, silicon carbide; and, ground oxides of transition metals, lanthanides and actinides.

The inclusion of particulate inorganic oxides such as silica and titania may have further utility than simply providing control of rheology of the compositions. The oxides can further contribute to enhancement in thermal conductivity, reduction in thermal expansion and enhancement in strength of the coating and can, moreover, inhibit partial discharge erosion caused by the concentration of electric fields at gaps existing between the insulative coating and the conductive wire.

To form a coating composition, the polymer solution and the adjuvants and additives are brought together and mixed. A multi-stage mixing process may be appropriate in certain circumstances to ensure the homogeneity of the coating compositions. For instance, silica and titania may be provided in colloidal form rather than in solid particulate form for admixture into the coating compositions.

Such adjuvants and additives can be used in such combination and proportions as desired, provided they do not adversely affect the nature and essential properties of the coating composition. While exceptions may exist in some cases, these adjuvants and additives typically do not in toto comprise more than 40 wt. % of the total composition and typically do not comprise more than 30 wt. % of the composition. In an alternative expression, which is not intended to be mutually exclusive of that given above, the coating compositions may be formulated to exhibit a dynamic viscosity of less than 10000 mPa·s, for instance less than 8000 mPa·s, at 25° C. Independently of or additional to these properties, the coating composition may be formulated to be bubble (foam) free upon formation, upon mixing with any adjuncts and upon subsequent application and thermal treatment.

As noted above, an aspect of the present disclosure is a process for the formation of an insulated wire, the process comprising: providing a conductive wire; coating the conductive wire with a polymer solution as defined herein above; and, subjecting the coated conductive wire to a thermal treatment to remove solvent therefrom.

Exemplary conductive wires include but are not limited to magnet wires. The provided wires can be formed from a variety of conductive materials including: metallic material, including for example, metals, silver, gold, copper, platinum, palladium, molybdenum, aluminium, nickel and tin; graphite; graphene; electrically conducting ceramics; and, electrically conducting polymeric materials. The provided wire may be of unitary construction or may be constituted by a number of constituent parts. The latter embodiment contemplates wires which are composed of a plurality of microwires or nanowires and wires which are comprised of conductive particles which are sintered, welded or agglomerated together.

The provided wire may possess a variety of cross-sectional shapes dependent upon the contemplated use of the wire: the wire may, for instance, possess a circular, elliptical or rectangular cross-section. Independently of that cross-sectional shape, the conductive wire may be exemplified by a diameter of from 0.01 to 5 mm, for instance from 0.01 to 2 mm or from 0.01 to 1 mm.

In accordance with the broadest process aspects of the present disclosure, the above described polymer solutions are applied to a substrate, such as the substrate of the conductive wire(s), and then thermally treated in situ. Prior to applying the solutions, it is often advisable to pre-treat the relevant surfaces to remove foreign matter there from: this step can, if applicable, facilitate the subsequent adhesion of the solutions thereto. Such treatments are known in the art and can be performed in a single or multi-stage manner. For conductive metal substrates, the treatments may be constituted by, for instance, the use of one or more of: an etching treatment with an acid suitable for the substrate and optionally an oxidizing agent; sonication; plasma treatment, including chemical plasma treatment, corona treatment, atmospheric plasma treatment and flame plasma treatment; immersion in a waterborne alkaline degreasing bath; treatment with a waterborne cleaning emulsion; treatment with a cleaning solvent, such as carbon tetrachloride or trichloroethylene; and, water rinsing, typically with deionized or demineralized water. In those instances where a waterborne alkaline degreasing bath is used, any of the degreasing agent remaining on the surface may be removed by rinsing the substrate surface with deionized or demineralized water.

In some embodiments, the adhesion of the solutions of the present disclosure to the optionally pre-treated substrate may be facilitated by the application of a primer thereto. Indeed, primer compositions may serve to ensure efficacious fixture times of the compositions on inactive substrates.

The solutions are then applied to the optionally pre-treated, optionally primed surfaces of the substrate by conventional application methods such as: immersion; coating dies; roll coating; felt application; and, spraying methods, including but not limited to air-atomized spray, air-assisted spray, airless spray and high-volume low-pressure spray.

It is recommended that the compositions be applied to a surface at a wet film thickness of from 10 to 500 μm. The application of thinner layers within this range is more economical and provides for a reduced likelihood of deleterious thick cured regions. However, great control must be exercised in applying thinner coatings or layers so as to avoid the formation of discontinuous cured films.

Conventional curing ovens may be used to heat the coated wire. For effective drying and curing, such ovens may be maintained at a temperature of from 300 to 700° C., for example from 400 to 600° C. The temperature that is suitable depends on the specific compounds present and the desired curing rate and can be determined in the individual case by the skilled artisan, using simple preliminary tests if necessary.

It is noted that more than one coat of polyamide-imide may be applied to the substrate. For example, the polyamide-imide may be applied in from 2 to 8 layers. Where multiple layers are applied, each individual layer may be at least partially dried prior to the application of a subsequent layer such that the at least partially dried preceding layer is able to substantially retain its shape upon exposure to ambient conditions. By “substantially retain its shape” is meant that at least 50% by volume, and more usually at least 80% or 90% by volume of the at least partially dried layer retains its shape and does not flow or deform upon exposure to ambient conditions for a period of 5 minutes. Under such circumstances, gravity typically may not substantially impact the shape of the at least partially cured or partially dried layer upon exposure to ambient conditions.

It is further noted that the polyamide-imide coating may constitute one or more layers of a multicoat system wherein the substrate is also provided with coating layer(s) comprising other polymers: mention in this regard may be made of polyesters, polyurethanes, polyimides and polyvinyl formal.

The following examples are illustrative of the present disclosure and are not intended to limit the scope of the disclosure in any way.

### EXAMPLES

The following commercial product was employed in the Examples below: DBE: Blend of the dibasic esters dimethyl glutarate, dimethyl succinate and dimethyl adipate, available as Rhodiasolv® RPDE from Solvay.

The following testing methods were employed in the Examples below:

Viscosity (η): Viscosity measurements were made with a Brookfield DV-IIT LV Cone and Plate viscometer. The viscometer was equipped with a CP-35 cone and was operated at a shear rate of 100 s−1 and a temperature of 23° C. The formulation was loaded into the viscometer at a volume of 0.5 mL and allowed to incubate at the given shear rate prior to the measurement collection period.

Solids Content: The solids content is the weight of the residue obtained from the enamel after stoving 1 g thereof at a temperature of 180° C. for 1 hour, in accordance with DIN 53 216. The solids content is expressed as a percentage by weight of the total weight of the enamel.

### Example 1

100 g γ-buryrolactone (GBL), 236 g dimethyl phthalate (DMP), 1 g triethylenediamine and 6 g benzyl alcohol were placed in a dry glass reactor. 128 g trimellitic anhydride (TMA), 68 g methylene diphenyl diisocyanate (MDI) and 71 g toluene diisocyanate (TDI) were added upon stirring at 40° C. The mixture was then heated over a two hour period to 90° C. and held at 90° C. for 4 hours until the CO2 formation ceased. The reaction temperature was increased to 150° C. and the batch was kept at 150° C. for a further 2 hours. 195 g dimethyl phthalate (DMP) and 195 g xylene were then added and the mixture was allowed to cool to room temperature.

The resulting enamel had a solids content of 35.0 wt. % and a viscosity of 7100 mPas. Dimethyl phthalate (DMP) represented 59.3 wt. % of the total weight of the solvents. The diisocyanate component consisted of: 40 mol. % MDI; and, 60 mol. % TDI.

### Example 2

380 g γ-buryrolactone (GBL), 1 g triethylenediamine and 15 g benzyl alcohol were placed in a dry glass reactor. 140 g trimellitic anhydride (TMA), 112 g methylene diphenyl diisocyanate (MDI) and 52 g toluene diisocyanate (TDI) were added upon stirring at 40° C. The mixture was then heated over a two hour period to 90° C. and held at 90° C. for 4 hours until the CO2 formation ceased. The reaction temperature was increased to 150° C. and the batch was kept at 150° C. for a further 2 hours. 300 g dimethyl phthalate (DMP) were added and the mixture was allowed to cool to room temperature.

The resulting enamel had a solids content of 37.0 wt. % and a viscosity of 2800 mPas. Dimethyl phthalate (DMP) represented 44.1 wt. % of the total weight of the solvents. The diisocyanate component consisted of: 60 mol. % MDI; and, 40 mol. % TDI.

### Example 3

470 g γ-buryrolactone (GBL), 150 g dimethyl phthalate (DMP), 1 g triethylenediamine and 14 g benzyl alcohol were placed in a dry glass reactor. 136 g trimellitic anhydride (TMA), 109 g methylene diphenyl diisocyanate (MDI) and 50 g toluene diisocyanate (TDI) were added upon stirring at 40° C. The mixture was then heated over a two hour period to 90° C. and held at 90° C. for 4 hours until the CO2 formation ceased. The reaction temperature was increased to 150° C. and the batch was kept at 150° C. for a further 2 hours. 70 g xylene were added and the mixture was allowed to cool to room temperature.

The resulting enamel had a solids content of 35.0 wt. % and a viscosity of 1150 mPas. Dimethyl phthalate (DMP) represented 21.7 wt. % of the total weight of the solvents. The diisocyanate component consisted of: 60mol. % MDI; and, 40 mol. % TDI.

### Example 4

390 g γ-buryrolactone (GBL), 1 g triethylenediamine and 15 g benzyl alcohol were placed in a dry glass reactor. 140 g trimellitic anhydride (TMA), 112 g methylene diphenyl diisocyanate (MDI) and 52 g toluene diisocyanate (TDI) were added upon stirring at 40° C. The mixture was then heated over a two hour period to 90° C. and held at 90° C. for 4 hours until the CO2 formation ceased. The reaction temperature was increased to 150° C. and the batch was kept at 150° C. for a further 2 hours. 20 g dimethyl phthalate (DMP), 180 g γ-buryrolactone (GBL) and 90 g xylene were added and the mixture was allowed to cool to room temperature.

The resulting enamel had a solids content of 31.0 wt. % and a viscosity of 700 mPas. Dimethyl phthalate (DMP) represented 2.9% of the total weight of the solvents. The diisocyanate component consisted of: 60 mol. % MDI; and, 40 mol. % TDI.

### Example 5

380 g γ-buryrolactone (GBL), 1 g triethylenediamine and 15 g benzyl alcohol were placed in a dry glass reactor. 140 g trimellitic anhydride (TMA), 112 g methylene diphenyl diisocyanate (MDI) and 52 g toluene diisocyanate (TDI) were added upon stirring at 40° C. The mixture was then heated over a two hour period to 90° C. and held at 90° C. for 4 hours until the CO2 formation ceased. The reaction temperature was increased to 150° C. and the batch was kept at 150° C. for a further 2 hours. 200 g dimethyl phthalate (DMP) and 100 g dibasic ester (DBE) were added and the mixture was allowed to cool to room temperature.

The resulting enamel had a solids content of 35.3 wt. % and a viscosity of 1930 mPas. Dimethyl phthalate (DMP) represented 29.4% of the total weight of the solvents. Dibasic ester (DBE) represented 14.7% of the total weight of the solvents. The diisocyanate component consisted of: 60 mol. % MDI; and, 40 mol. % TDI.

### Example 6

380 g γ-buryrolactone (GBL), 1 g triethylenediamine and 15 g benzyl alcohol were placed in a dry glass reactor. 138 g trimellitic anhydride (TMA), 126 g methylene diphenyl diisocyanate (MDI) and 40 g toluene diisocyanate (TDI) were added upon stirring at 40° C. The mixture was then heated over a two hour period to 90° C. and held at 90° C. for 4 hours until the CO2 formation ceased. The reaction temperature was increased to 150° C. and the batch was kept at 150° C. for a further 2 hours. 200 g dimethyl phthalate (DMP) and 100 g dibasic ester (DBE) were added and the mixture was allowed to cool to room temperature.

The resulting enamel had a solid content of 34.8 wt. % and a viscosity of 1770 mPas. Dimethyl phthalate (DMP) represented 29.4% of the total weight of the solvents. Dibasic ester (DBE) represented 14.7% of the total weight of the solvents. The diisocyanate component consisted of: 68 mol. % MDI; and, 32 mol. % TDI.

### Example 7

280 g γ-buryrolactone (GBL), 100 g dimethyl phthalate (DMP), 1 g triethylenediamine and 15 g benzyl alcohol were placed in a dry glass reactor. 140 g trimellitic anhydride (TMA), 112 g methylene diphenyl diisocyanate (MDI) and 52 g toluene diisocyanate (TDI) were added upon stirring at 40° C. The mixture was then heated over a two hour period to 90° C. and held at 90° C. for 4 hours until the CO2 formation ceased. The reaction temperature was increased to 150° C. and the batch was kept at 150° C. for a further 2 hours. 130 g dimethyl phthalate (DMP) and 170 g dibasic ester (DBE) were added and the mixture was allowed to cool to room temperature.

The resulting enamel had a solid content of 35.1 wt. % and a viscosity of 2250 mPas. Dimethyl phthalate (DMP) represented 33.8% of the total weight of the solvents. Dibasic ester (DBE) represented 25.0% of the total weight of the solvents. The diisocyanate component consisted of: 60 mol. % MDI; and, 40 mol. % TDI.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims. Moreover, all combinations of the aforementioned components, compositions, method steps, formulation steps, etc. are hereby expressly contemplated for use herein in various non-limiting embodiments even if such combinations are not expressly described in the same or similar paragraphs.

With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the ranges and subranges enumerated herein sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. An individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims. Lastly, it will be understood that the term “about” with regard to any of the particular numbers and ranges described herein is used to designate values within standard error, equivalent function, efficacy, final loading, etc., as understood by those of skill in the art with relevant conventional techniques and processes for formulation and/or utilizing compounds and compositions such as those described herein. As such, the term “about” may designate a value within 10, alternatively within 5, alternatively within 1, alternatively within 0.5, alternatively within 0.1, % of the enumerated value or range.

While the present disclosure has been described with respect to particular embodiments thereof, it is apparent that numerous other forms and modifications will be obvious to those skilled in the art. The appended claims and this disclosure generally should be construed to cover all such obvious forms and modifications, which are within the true scope of the present disclosure.

1. A polyamide-imide solution comprising:
a polymer including the structural unit of Formula (II) 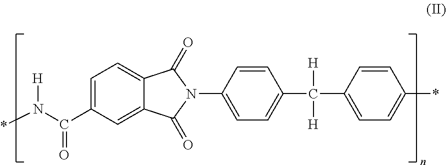
wherein: n is an integer of from 2 to 400; and,
a solvent comprising, based on the total weight of solvent:
from 0.1 to 100 wt. % of i) at least one compound in accordance with Formula (IA)
ROOC—A²—COOR (IA)
wherein: A² is a C₃-C₈ alkylene or a C₆ arylene; and,
each R is independently a C₁-C₂ alkyl group; and,
from 0 to 99.9 wt. % of ii) at least one aprotic compound which does not meet Formula (IA) and which has a boiling point of at least 150° C. as measured at 1 Bar pressure.

2. A method for producing a polyamide-imide solution, said method comprising:
a) preparing a first solution of a polyamide-imide polymer by reacting, at a temperature of from 60 to 180° C. and in the presence of a first solvent and a catalyst:
a1) a diisocyanate component comprising at least one diisocyanate chosen from: monomeric methylene diphenyl diisocyanate (MDI); polymeric methylene diphenyl diisocyanate (pMDI); hexamethylene diisocyanate (HDI); isophorone diisocyanate (IPDI); dicyclohexylmethane diisocyanate (H-MDI); xylene diisocyanate (XDI); hydrogenated xylene diisocyanate; tolylene diisocyanate (TDI); diphenylsulfone diisocyanate (SDI); m-xylylene diisocyanate; and, mixtures thereof; and,
a2) an anhydride component comprising trimellitic anhydride (TMA) wherein the first solvent comprises at least one aprotic compound which has a boiling point of at least 150° C. as measured at 1 Bar pressure; and,
b) diluting the first polymer solution with a second solvent to produce a second solution of the polyamide-imide polymer, wherein the second solvent is distinct from the first solvent,
wherein at least one of the first solvent and second solvent comprises:
i) at least one compound in accordance with Formula (IA)
ROOC—A²—COOR (IA)
wherein: A² is a C₃-C₈ alkylene or a C₆ arylene; and,
each R is independently a C₁-C₂ alkyl group.

3. The method according to claim 2, wherein the first solvent comprises:
i) said at least one compound in accordance with Formula (IA); and
ii) at least one aprotic compound which does not meet Formula (IA) and which has a boiling point of at least 150° C. as measured at 1 Bar pressure.

4. The method according to claim 3, wherein the first solvent comprises, based on a total weight of solvent:
from 0.5 to 70 wt. % of i) the at least one compound in accordance with Formula (IA); and
from 30 to 99.5 wt. % of ii) the at least one aprotic compound.

5. The method according to claim 2, wherein in Formula (IA):
A² is a C₃-C₆ alkylene group or a C₆ arylene group; and
each R is independently a C₁-C₂ alkyl group.

6. The method according to claim 2, wherein the at least one compound in accordance with Formula (IA) is chosen from: dimethyl phthalate; diethyl phthalate; dimethyl glutarate; diethyl glutarate; dimethyl adipate; diethyl adipate; and, mixtures thereof.

7. The method according to claim 3, wherein the at least one aprotic compound is further defined as a nitrogen containing polar aprotic compound which has a boiling point of at least 150° C. as measured at 1 Bar pressure.

8. The method according to claim 3, wherein ii) the at least one aprotic compound is chosen from: γ-butyrolactone; cyclohexanone; methylcyclohexanone; N-methyl-2-pyrrolidone (NMP); N-ethyl-2-pyrrolidone (NMP); N-butyl-2-pyrrolidone (NBP); N,N-dimethylacetamide; N-formyl morpholine; N-acetyl morpholine; 3-methoxy N,N′-dimethylpropanamide (MDP); and, mixtures thereof.

9. The method according to claim 2 wherein the diisocyanate component comprises at least one diisocyanate chosen from: monomeric methylene diphenyl diisocyanate (MDI); polymeric methylene diphenyl diisocyanate (pMDI); hexamethylene diisocyanate (HDI); tolylene diisocyanate (TDI); and, mixtures thereof.

10. The method according to claim 2, wherein the diisocyanate component comprises, based on the total number of moles of diisocyanate:
from 10 to 90 mol. % of monomeric methylene diphenyl diisocyanate (MDI); and,
from 90 to 10 mol. % of at least one diisocyanate chosen from: polymeric methylene diphenyl diisocyanate (pMDI); hexamethylene diisocyanate (HDI); isophorone diisocyanate (IPDI); dicyclohexylmethane diisocyanate (H-MDI); xylene diisocyanate (XDI); hydrogenated xylene diisocyanate; tolylene diisocyanate (TDI); diphenylsulfone diisocyanate (SDI); m-xylylene diisocyanate; and, mixtures thereof.

11. The method according to claim 2, wherein the anhydride component comprises, based on the total number of moles of anhydride:
from 80 to 100 mol. % of trimellitic anhydride (TMA); and
from 0 to 20 mol. % of least one tetracarboxylic dianhydride.

12. The method according to claim 2, wherein the reacting components further comprise:
a3) at least one polycarboxylic acid.

13. The method according to claim 2, wherein the catalyst is a tertiary amine.

14. The method according to claim 2, wherein the second solvent comprises at least one compound in accordance with Formula (IA):
ROOC—A2—COOR (IA)
wherein: A² is a C₃-C₈ alkylene or a C₆ arylene; and,
each R is independently a C₁-C₂ alkyl group.

15. The method according to claim 2, wherein the second solvent comprises at least one non-polar compound having a boiling point of less than 225° C.

16. The method according to claim 15, wherein the second solvent comprises at least one compound chosen from: C₁-C₈ linear alkanes; cyclic alkanes; C₁-C₈ branched alkanes; C₁-C₈ alkyl halides; aromatics; and, mixtures thereof.

17. A polyamide-imide solution obtained in accordance with the method as defined in claim 2.

18. The polyamide-imide solution of claim 17 having a solids content of from 20 to 50 wt. % as determined in accordance with DIN 53216.

19. A process for forming an insulated wire comprising:
providing a conductive wire;
coating the conductive wire with a polyamide-imide solution as defined in claim 17; and
subjecting the coated conductive wire to a thermal treatment to remove solvent therefrom.

20. A method for producing a polyamide-imide solution, said method comprising:
a) reacting, at a temperature of from 60 to 180° C. and in the presence of a solvent and a catalyst:
a1) a diisocyanate component comprising at least one diisocyanate chosen from:
monomeric methylene diphenyl diisocyanate (MDI); polymeric methylene diphenyl diisocyanate (pMDI); hexamethylene diisocyanate (HDI); isophorone diisocyanate (IPDI);
dicyclohexylmethane diisocyanate (H-MDI); xylene diisocyanate (XDI); hydrogenated xylene diisocyanate; tolylene diisocyanate (TDI); diphenylsulfone diisocyanate (SDI); m-xylylene diisocyanate; and, mixtures thereof; and
a2) an anhydride component comprising trimellitic anhydride (TMA) to produce a solution of a polyamide-imide polymer, wherein the solvent comprises:
from 0.1 to 100 wt. % of i) the at least one compound in accordance with Formula (I)
ROOC—A¹—COOR (I)
wherein: A1 is a C₁-Cs alkylene or a C₆ arylene; and
each R is independently a C₁-C₂ alkyl group; and
from 0 to 99.9 wt. % of ii) at least one aprotic compound which does not meet Formula (I) and which has a boiling point of at least 150° C. as measured at 1 Bar pressure.
